(19) United States
(12) Patent Application Publication
(10) Pub. No.: US 2022/0350952 A1
(43) Pub. Date: Nov. 3, 2022

(54) SYSTEMS AND METHODS FOR MODIFYING EMBEDDED ELEMENTS FOR RENDERING WITHIN A WEBSITE

(71) Applicant: Wove Labs, Inc., Denver, CO (US)

(72) Inventor: David Xu, Denver, CO (US)

(21) Appl. No.: 17/731,648

(22) Filed: Apr. 28, 2022

Related U.S. Application Data
(60) Provisional application No. 63/180,788, filed on Apr. 28, 2021.

(51) Int. Cl. G06F 40/106; H04L 67/02; H04L 67/146; H04L 65/401; G06F 40/143; G06F 16/957

(52) U.S. Cl. CPC G06F 40/106; H04L 67/02; H04L 67/146; H04L 65/4015; G06F 40/143; G06F 16/9577

(57) ABSTRACT

In general, various aspects of the present invention provide methods, apparatuses, systems, computing devices, computing entities, and/or the like for intercepting HTTP traffic (e.g., including HTTP requests and responses) for displaying a third-party website in an embedded element (e.g., inline frame) of a website. The extension may, for example, intercept HTTP requests in order to inject one or more required cookies and/or other HTTP headers in order to pass session information and other information along with the HTTP request. The browser extension may, in various other embodiments, be configured to: (1) intercept an HTTP response (e.g., to a modified HTTP request sent via the browser extension); (2) modify the HTTP response; and (3) cause a web browser to render a target website based at least in part on the modified HTTP response.

### CROSS-REFERENCE TO RELATED APPLICATIONS

This application claims the benefit of U.S. Provisional Patent Application Ser. No. 63/180,788, filed Apr. 28, 2021, which is hereby incorporated herein by reference in its entirety.

### TECHNICAL FIELD

The present disclosure is generally related to a computational framework used for modifying embedded elements within websites and other user interface modification.

### BACKGROUND

Integrating third party computing functionality into a first party computing system (e.g., integrating third party computing functionality into a website, piece of software, etc.) may result in improper rending of the third party computing functionality within a user interface from which the third party computing functionality is accessible at the first party computing resource. Accordingly, there is a need for improved systems and methods to address these and other deficiencies.

### SUMMARY

In general, various aspects of the present disclosure provide methods, apparatuses, systems, computing devices, computing entities, and/or the like for integrating third party computing functionality into first party computing entitles.

In particular embodiments, a computer-implemented method for modifying an embedded element within a webpage, the method comprises: (1) intercepting, by computing hardware, a first HTTP response from a target website to a first HTTP request originating from the embedded element within the webpage; (2) modifying, by the computing hardware, the first HTTP response based on the target website to generate a modified HTTP response; and (3) causing, by the computing hardware, the embedded element to display the target website based on the modified HTTP response. In a particular embodiment, the embedded element comprises an iframe. In some embodiments, the method further comprises defining, by the computing hardware, at least one attribute for the iframe based at least in part on the modified HTTP response. In particular aspects, the method further comprises: (1) intercepting, by the computing hardware, the first HTTP request from the embedded element prior to sending the first HTTP request; (2) injecting, by the computing hardware, one or more headers into the first HTTP request to create a second HTTP request; and (3) sending, by the computing hardware, the second HTTP request in place of the first HTTP request.

In particular embodiments, the method further comprises: (1) accessing a cookie store associated with the target website; and (2) modifying the first HTTP response to inject at least one cookie from the cookie store into the first HTTP response. According to some aspects, the target website comprises a collaborative user interface. In still other aspects, the method further comprises enabling a plurality of users to access the collaborative user interface simultaneously via a respective embedded element in a be browser on a respective computing device of each user of the plurality of users. In a particular embodiments, the embedded element comprises a third-party website.

In various embodiments, a computer-implemented method for modifying a website for display in an inline frame, comprises: (1) providing, by computing hardware, a browser extension for installation on a computing device; (2) receiving, by the computing hardware, via the browser extension, a request to render the website in the inline frame; (3) intercepting, by the computing hardware, an HTTP request associated with the request to render the website; (4) modifying, by the computing hardware, the HTTP request to a modified HTTP request by injecting at least one of: (1) one or more cookies; and (2) one or more HTTP headers into the HTTP request; (5) sending, by the computing hardware, to a third-party server based on a target URL associated with the HTTP request, the modified HTTP request; (6) receiving, by the computing hardware, in response to the modified HTTP request, an HTTP response; (7) modifying, by the computing hardware, the HTTP response to a modified HTTP response based on the target URL; and (8) configuring a computing device to display the website associated with the target URL based on the modified HTTP response within an inline frame on a second website.

In various aspects, the website comprises a collaborative user interface. In such aspects, the method may further comprise\ enabling a second computing device to access the collaborative user interface simultaneously via a respective inline frame in a respective browser on the second computing device. In any embodiment described herein, modifying the HTTP request to a modified HTTP request may comprise: (1) accessing a database defining modification requirements for proper rendering of the website within the inline frame; (2) selecting at least one of the one or more cookies or the one or more HTTP headers based on the modification requirements; and (3) injecting the selected at least one of: (1) the one or more cookies; or (2) the one or more HTTP headers into the HTTP request. In some embodiments, the website provides third-party computing functionality to the second website. In other embodiments, the modified HTTP response corrects one or more rendering issues resulting from displaying the website within the inline frame according to the HTTP response. In particular aspects, the inline frame is disposed within the second website.

A method, according to various embodiments, involves rendering third-party content in an embedded element of a website. In some embodiments, the method comprises: (1) generating a graphical user interface in a portion of a browser window of a web browser executing on a computing device; and (2) in response to the web browser retrieving a webpage to be rendered in the browser window, modifying the webpage to be rendered based at least in part on a source of the webpage to be rendered. In some aspects, modifying the webpage to be rendered comprises: (1) intercepting an HTTP response associated with the webpage to be rendered; (2) modifying the HTTP response into a modified HTTP response based at least in part on the webpage to be rendered by modifying at least one attribute of the HTTP response; and (3) configuring the computing device to display the website to be rendered within the portion of the browser window based at least in part on the modified HTTP request, the website to be rendered comprising the third-party content. In a particular embodiment, the embedded element comprises an inline frame. In other embodiments, the embedded element comprises WebView executing within a native application on the computing device.

In some embodiments, the method further comprises providing, by the computing hardware, a browser extension for installation on the computing device. In such embodiments, modifying the webpage to be rendered comprises modifying the webpage to be rendered by the browser extension prior to rendering the webpage. In a particular embodiment, modifying at least one attribute of the HTTP response comprises at least one of injecting at least one cookie into the HTTP response or modifying a header of the HTTP response. In particular embodiments, the modified HTTP response corrects one or more rendering issues resulting from displaying the website within the portion of the browser window according to the HTTP response. According to various aspects, the embedded element defines the portion of the browser window.

In accordance with various aspects, a system is provided comprising a non-transitory computer-readable medium storing instructions and a processing device communicatively coupled to the non-transitory computer-readable medium. In particular aspects, the processing device is configured to execute the instructions and thereby perform operations that may include, for example, the steps performed within the method referenced above. In addition in accordance with various aspects, a non-transitory computer-readable medium having program code that is stored thereon. In particular aspects, the program code executable by one or more processing devices performs operations that may include, for example, the steps performed within the method referenced above.

### BRIEF DESCRIPTION OF THE DRAWINGS

In the course of this description, reference will be made to the accompanying drawings, which are not necessarily drawn to scale, and wherein:

FIG. 1 is a block diagram illustrating an exemplary system architecture that may be used in accordance with various embodiments of the present disclosure;

FIG. 2 is a schematic diagram of a computing entity that may be used in accordance with various embodiments of the present disclosure;

FIG. 3 is a flowchart of a process flow for modifying HTTP requests and responses to facilitate an accurate rendering of a website within an embedded element in accordance with various embodiments of the present disclosure;

FIGS. 4-8 depict exemplary screen displays and graphical user interfaces (GUIs) according to various embodiments of the system, which a user may encounter based on whether the system and method described herein are being utilized by a computing device used by the user.

### DETAILED DESCRIPTION

Various embodiments for practicing the technologies disclosed herein are described more fully hereinafter with reference to the accompanying drawings, in which some, but not all embodiments of the technologies disclosed are shown. Indeed, the embodiments disclosed herein are provided so that this disclosure will satisfy applicable legal requirements and should not be construed as limiting or precluding other embodiments applying the teachings and concepts disclosed herein. Like numbers in the drawings refer to like elements throughout.

### Overview

In various embodiments, a browser extension may be configured to intercept HTTP traffic (e.g., including HTTP requests and responses) for displaying a third-party website in an embedded element (e.g., inline frame) of a website. The extension may, for example, intercept HTTP requests in order to inject one or more required cookies and/or other HTTP headers in order to pass session information and other information along with the HTTP request. The browser extension may, in various other embodiments, be configured to: (1) intercept an HTTP response (e.g., to a modified HTTP request sent via the browser extension); (2) modify the HTTP response; and (3) cause a web browser to render a target website based at least in part on the modified HTTP response. In particular other embodiments, the browser extension is configured to fix a way that a target website (e.g., third party website) is rendered when placed within an embedded element of a website. As may be understood in light of this disclosure, particular websites (e.g., third-party websites) may not render properly (e.g., may not display within the embedded element in the same way that the particular website or third-party website would display natively within a web browser).

In particular embodiments, the browser extension may be configured to inject one or more HTTP headers into one or more of an HTTP request and an HTTP response. The browser extension may be further configured to intercept one or more cookie stores (e.g., for the browser, third-party website, etc.) in order to track an origin and domain associated with each cookie in the cookie store. The system may, for example, be configured to inject one or more cookies (e.g., via any suitable header modification) into an HTTP request and/or HTTP response, as necessary, based on the cookie store.

In still other embodiments, the system may be embodied in a manner other than as a browser extension. For example, in particular embodiments one or more features described herein may be native to a particular web browser (e.g., one or more web browsers). In still other embodiments, the system may be configured as a software application executing on a local computing device, server device, etc. In various embodiments, the system described herein is configured to enable users of video-conferencing software to collaborate using a piece of third-party software (e.g., web-based software) within the video-conferencing software (e.g., or using a website through which the users are attending a video conference call). In still other embodiments, the system may be embodies as any suitable piece of computing software and/or hardware, configured to inject computing functionality provided by a third party computing system (e.g., via a web site, piece of software, etc.) into a first party computing entity (e.g., such as via a first party website, first party piece of software, etc.). In this way, the system may be configured to provide a seamless integration of the third party computing functionality into the first party software such that a user of the first party software (e.g., a user accessing a first party website) may experience the third party computing functionality as though it were native to the first party computing entity.

Example System Architecture

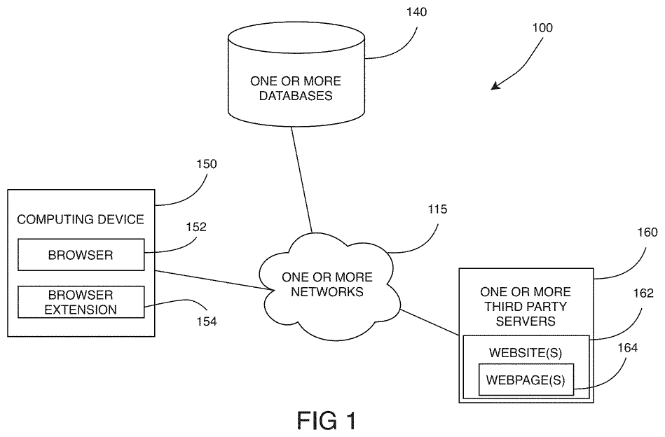

FIG. 1 is a block diagram of an HTTP Request and Response Modification System 100 according to a particular embodiment. In various embodiments, the HTTP Request and Response Modification System 100 is configured to intercept and modify one or more HTTP Requests and Responses in order to ensure accurate rendering and use of a third-party website within an embedded element (e.g., inline frame) of a webpage (e.g., a first party webpage).

As may be understood from FIG. 1, the HTTP Request and Response Modification System 100 includes one or more computer networks 115, One or More Databases 140 or other data structures, one or more remote computing devices 150 (e.g., a desktop computer, laptop computer, tablet computer, smartphone, etc.), and One or More Third Party Servers 160. In particular embodiments, the one or more computer networks 115 facilitate communication between the One or More Databases 140, one or more remote computing devices 150 (e.g., a desktop computer, laptop computer, tablet computer, smartphone, etc.), and One or More Third Party Servers 160. Although in the embodiment shown in FIG. 1, the One or More Databases 140, one or more remote computing devices 150 (e.g., a desktop computer, laptop computer, tablet computer, smartphone, etc.), and One or More Third Party Servers 160 are shown as separate servers and/or devices, it should be understood that in other embodiments, one or more of these servers and/or computing devices may comprise a single server, a plurality of servers, one or more cloud-based servers, or any other suitable configuration. It should be further understood that any particular name given to any particular server in the course of this description should not be understood to imply any limit to any functionality that such a server may provide to the system. For example, any functionality described herein may be implemented via any computing device and/or combination of computing devices described herein.

The one or more computer networks 115 may include any of a variety of types of wired or wireless computer networks such as the Internet, a private intranet, a public switch telephone network (PSTN), or any other type of network. The communication link between the one or more remote computing devices 150 and the One or More Third Party Servers 160 may be, for example, implemented via a Local Area Network (LAN) or via the Internet. In other embodiments, the One or More Databases 140 may be stored either fully or partially on any suitable server or combination of servers described herein.

In various embodiments, the Computing Device 150 includes a web browser 152 and may further include one or more browser extensions 154. In various embodiments, the web browser 152 is configured to process the files retrieved from one or more servers (e.g., the One or More Third Party Servers 160) to display digital content to a user via the Computing Device 150. In various embodiments, one or more plug-ins (e.g., Flash applications, Java applets, etc.) may be used by the web browser 152 to process files and display the digital content to the user. For example, in any embodiment described herein, the plug-ins may enable the web browser to process webpages 164 that embed content that it would otherwise not be able to process, (e.g., Flash videos, portable document formats (PDFs), or Java applets).

In particular embodiments, the web browser 152 may be configured to load a browser extension 154 that may be executed in the browser context to extend the functionality of the web browser 152. For example, the browser extension 120 may be downloaded and installed on a computing device 150 executing the web browser 152, and the web browser 152 can call or invoke the browser extension 152 when the computing device 150 launches the web browser 152 to integrate the functionality of the browser extension 154 into the web browser 152.

In any embodiment described herein, the browser extension 154 may be configured to extend the functionality of the web browser 152 to provide a dynamic browsing environment in which the web browser 152 and the browser extension 154 respond to the digital content being displayed in a browser window of the web browser 125 and/or the URL associated with the digital content being displayed. In particular embodiments, the browser extension 154 is configured to intercept and modify one or more HTTP requests sent by and HTTP responses received by the web browser 152. In various embodiments the one or more HTTP requests sent by and HTTP responses received by the web browser 152 include one or more HTTP requests and HTTP responses sent and received for display in an embedded element within the web browser 152 (e.g., in an inline frame).

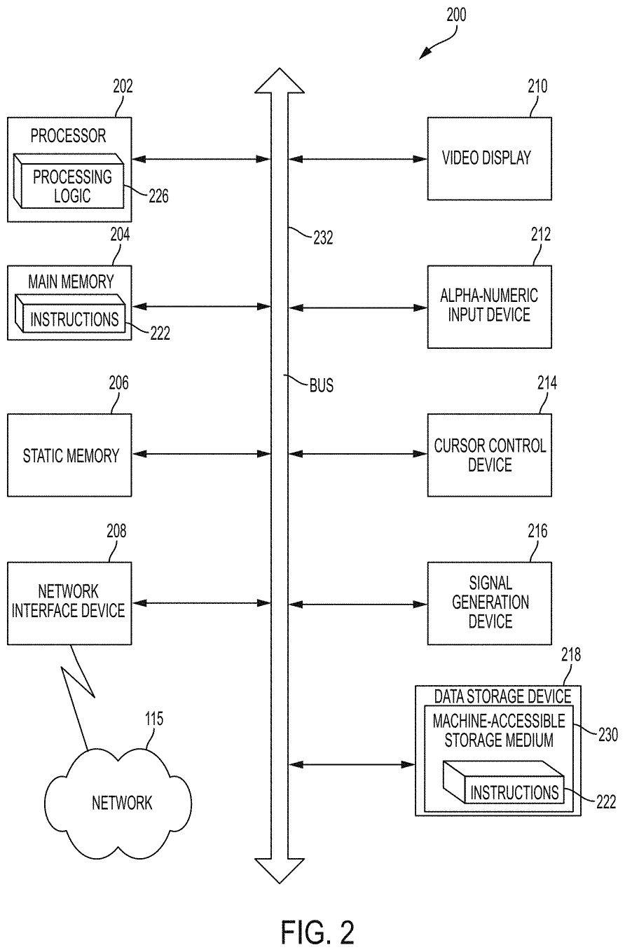

FIG. 2 illustrates a diagrammatic representation of a computer 200 that can be used within the HTTP Request and Response Modification System 100, for example, as a client computer (e.g., one or more remote computing devices 150 shown in FIG. 1), or as a server computer (e.g., One or More Third Party Servers 160 shown in FIG. 1). In particular embodiments, the computer 200 may be suitable for use as a computer within the context of the HTTP Request and Response Modification System 100 that is configured to intercept and modify HTTP requests and responses.

In particular embodiments, the computer 200 may be connected (e.g., networked) to other computers in a LAN, an intranet, an extranet, and/or the Internet. As noted above, the computer 200 may operate in the capacity of a server or a client computer in a client-server network environment, or as a peer computer in a peer-to-peer (or distributed) network environment. The Computer 200 may be a personal computer (PC), a tablet PC, a set-top box (STB), a Personal Digital Assistant (PDA), a cellular telephone, a smartphone, a web appliance, a server, a network router, a switch or bridge, or any other computer capable of executing a set of instructions (sequential or otherwise) that specify actions to be taken by that computer. Further, while only a single computer is illustrated, the term “computer” shall also be taken to include any collection of computers that individually or jointly execute a set (or multiple sets) of instructions to perform any one or more of the methodologies discussed herein.

An exemplary computer 200 includes a processing device 202, a main memory 204 (e.g., read-only memory (ROM), flash memory, dynamic random access memory (DRAM) such as synchronous DRAM (SDRAM) or Rambus DRAM (RDRAM), etc.), static memory 206 (e.g., flash memory, static random access memory (SRAM), etc.), and a data storage device 218, which communicate with each other via a bus 232.

The processing device 202 represents one or more general-purpose processing devices such as a microprocessor, a central processing unit, or the like. More particularly, the processing device 202 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. The processing device 202 may also be one or more special-purpose processing devices such as an application specific integrated circuit (ASIC), a field programmable gate array (FPGA), a digital signal processor (DSP), network processor, or the like. The processing device 202 may be configured to execute processing logic 226 for performing various operations and steps discussed herein.

The computer 200 may further include a network interface device 208. The computer 200 also may include a video display unit 210 (e.g., a liquid crystal display (LCD) or a cathode ray tube (CRT)), an alphanumeric input device 212 (e.g., a keyboard), a cursor control device 214 (e.g., a mouse), and a signal generation device 216 (e.g., a speaker).

The data storage device 218 may include a non-transitory computer-accessible storage medium 230 (also known as a non-transitory computer-readable storage medium or a non-transitory computer-readable medium) on which is stored one or more sets of instructions (e.g., software instructions 222) embodying any one or more of the methodologies or functions described herein. The software instructions 222 may also reside, completely or at least partially, within main memory 204 and/or within processing device 202 during execution thereof by computer 200—main memory 204 and processing device 202 also constituting computer-accessible storage media. The software instructions 222 may further be transmitted or received over a network 115 via network interface device 208.

While the computer-accessible storage medium 230 is shown in an exemplary embodiment to be a single medium, the term “computer-accessible storage medium” should be understood to include a single medium or multiple media (e.g., a centralized or distributed database, and/or associated caches and servers) that store the one or more sets of instructions. The term “computer-accessible storage medium” should also be understood to include any medium that is capable of storing, encoding or carrying a set of instructions for execution by the computer and that cause the computer to perform any one or more of the methodologies of the present invention. The term “computer-accessible storage medium” should accordingly be understood to include, but not be limited to, solid-state memories, optical and magnetic media, etc.

### Exemplary System Platform

Various embodiments of the HTTP Request and Response Modification System 100 may be implemented in the context of any suitable system. For example, the HTTP Request and Response Modification System 100 may be implemented to intercept and modify one or more HTTP Requests and Responses in order to ensure accurate rendering and use of a third-party website within an embedded element of a webpage. Various aspects of the system's functionality may be executed by certain system modules, including a HTTP Request and Response Modification Module 300. This module is discussed in greater detail below.

Although this module is presented as a series of steps, it should be understood in light of this disclosure that various embodiments of the HTTP Request and Response Modification Module 300 described herein may perform the steps described below in an order other than in which they are presented. In still other embodiments, the HTTP Request and Response Modification Module 300 may omit certain steps described below. In various other embodiments, the HTTP Request and Response Modification Module 300 may perform steps in addition to those described (e.g., such as any other steps described herein, etc.).

In particular embodiments, the steps that the system executes when executing any of the modules described herein may be performed by any suitable computer server/device or combination of computer servers/devices (e.g., any suitable computing device, server, or combination of computing device and/or server described herein).

HTTP Request and Response Modification Module

In particular embodiments, an HTTP Request and Response Modification Module 300 is configured to intercept and modify one or more HTTP Requests and Responses in order to ensure accurate rendering and use of a third-party website (e.g., and/or other computing functionality) within an embedded element (e.g., inline frame) of a webpage (e.g., or piece of software such as within a WebView).

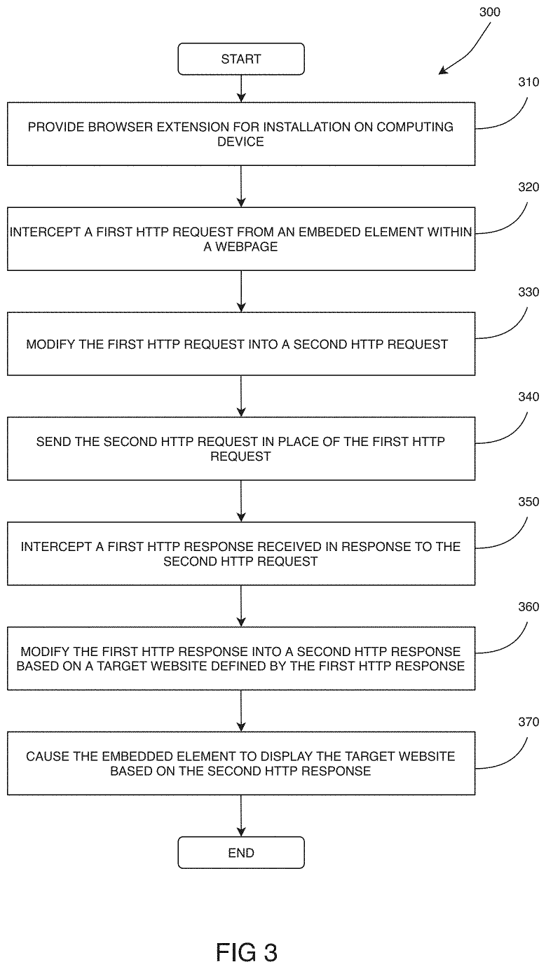

Turning to FIG. 3, in particular embodiments, when executing the HTTP Request and Response Modification Module, the system begins, at Step 310, by providing a browser extension for installation on a computing device. In particular embodiments, the system may provide the browser extension for installation and use by a particular web browser (e.g., Google Chrome, Internet Explorer, Mozilla Firefox, Safari, etc.). In various embodiments, a user may select a browser extension (e.g., browser extension 154) to download and locally install on the computing device 150. In such an embodiment, the browser 152 may download the browser extension 152 and store the browser extension 154 locally (e.g., on the computing device 150) for use by the browser 152. In particular embodiments, the browser extension 154 may be configured to identify a call to a second website within a first webpage (e.g., within an embedded element such as an inline frame on the first webpage) and perform one or more of the functions described herein in response to identifying the embedded element that is directed to a URL of the second website. In still other embodiments, any functionality described herein may be performed natively by a particular web browser. In still other embodiments, the functionality described herein may be implemented via any suitable software application. For example, the functionality may be performed by a software application executing a browser instance within a WebView or other embedded browser in the software application. In particular embodiments, one or more features described herein may be performed at one or more remote server devices to a computing device requesting display of a particular website (e.g., third-party website) within an embedded element on a web browser or other piece of software (e.g., one or more remote servers may be configured to perform one or more steps related to intercepting HTTP traffic and other steps described below).

In various embodiments, the browser extension may be configured to identify a particular embedded element (e.g., inline frame) within a webpage. In any embodiment described herein, the system (e.g., the browser extension or native software application such as a web browser with integrated functionality described herein) may be configured to determine, based on the embedded element, a URL of a third-party website that is to be embedded in the iframe. The system may then be configured to make one or more modifications to an HTTP request and/or response discussed herein based at least in part on the URL. For example, particular websites may display in a useable manner within an embedded element (e.g., iframe). In particular embodiments, such particular websites may not require modification to any HTTP requests and/or responses associated therewith in order for the websites to properly display (e.g., render properly).

Continuing to Step 320, the system is configured to intercept a first HTTP request from an embedded element (inline frame) within a webpage. In particular embodiments, the system is configured to intercept the first HTTP request using any suitable hook, combination of hooks, interceptor function(s), etc. In various embodiments, the system is configured to intercept the first HTTP request from the embedded element (e.g., inline frame) on the first webpage. For example, in particular embodiments, the first webpage may include an embedded element (e.g., inline frame) configured to display content from a third-party website (e.g., the third-party website). In particular embodiments, the first webpage may be configured to enable a user accessing the first webpage to select a particular third-party webpage for integration into the first webpage (e.g., to collaborate with one or more other uses accessing the first webpage from a respective computing device). In a particular example, the first party webpage comprises a video-conferencing product configured to enable a plurality of users to simultaneously video conference (e.g., transmit one or more video images while viewing one or more video images of at least a portion of each of the other users of the plurality of users) while collaborating together while using a third-party web site (e.g., a third-party website at least partially embedded within the first webpage) or other third-party computing functionality or software simultaneously.

In particular embodiments, the system is configured to intercept an HTTP request to the third-party website (e.g., prior to transmitting the HTTP request associated with the third-party website to the third-party website). In various embodiments, the system is configured to intercept the HTTP request using a suitable browser extension. In such embodiments, the system is configured to intercept the HTTP request prior to transmitting the HTTP request to a third-party server (e.g., a third-party server associated with a URL defined by the HTTP request). In particular embodiments, the system is configured to intercept an HTTP request from an embedded element (e.g., inline frame) within a webpage. In various embodiments, the HTTP request comprises a request to display a website at a particular URL within the embedded element (e.g., inline frame) on the webpage (e.g., first webpage). In still other embodiments, the system is configured to intercept an HTTP request from a WebView (e.g., embedded browser instance) within a native software application executing on a computing device. In various embodiments, the HTTP request comprises a request to display a website at a particular URL within the WebView within the software application.

Next, at Step 330, the system is configured to modify the first HTTP request into a second HTTP request. In various embodiments, modifying the first HTTP request into the second HTTP request comprises, for example: (1) injecting one or more cookies into the first HTTP request; (2) modifying a header of the first HTTP request; and/or (3) make any other modification. The system may, for example, modify the first HTTP request in order to pass session information from a user's device accessing the first webpage (e.g., or software application) to a website associated with the first HTTP request. In various embodiments, they system is configured to modify the first HTTP request based at least in part on a target website defined by the first HTTP request. For example, a particular target website may require one or more cookies or other header data in order to function properly. When modifying the first HTTP request, the system may identify, based on the required one or more cookies or header data for the target website, what modifications to make to the first HTTP request. The system may, for example, access a database of header and or cookie data for a plurality of target websites, and identify the appropriate headers and/or cookies required for the target website in order to inject the proper cookies and/or header data to the first HTTP request.

At Step 340, the system is configured to send the second HTTP request in place of the first HTTP request. The system may, for example transmit the second HTTP request to one or more servers based on a URL associated with the first HTTP request. In particular embodiments, sending the second HTTP request in place of the first HTTP request may enable the system to inject one or more additional attributes into the first HTTP request in order to facilitate a particular functionality for the third-party website while the third-party website is displayed within the inline frame (e.g., or another embedded element), WebView, etc. These one or more additional attributes may include, for example: one or more cookies, one or more settings, etc.

Returning to Step 350, the system is configured to intercept a first HTTP response received in response to the second HTTP request. In particular embodiments, the system is configured to intercept the first HTTP response prior to displaying the third-party website within the inline frame. In this way, by intercepting the first HTTP response, the system may be configured to at least temporarily prevent the embedded element from displaying a webpage based on the first HTTP response (e.g., until the system is able to modify the first HTTP response onto a second HTTP response as discussed below).

In various embodiments, at Step 360, the system is configured to modify the first HTTP response into a second HTTP response based on a target website defined by the first HTTP response. For example, different target websites may require different types of response modification and header insertion in order to render properly within an embedded element. In various embodiments, the system is configured to determine, based on the target website, the appropriate modifications to apply to the HTTP requests and/or headers to insert. The system may, for example, access a database that defines required cookie and/or header and/or other requirements related to rending third-party webpages within embedded elements. The system may then use the information from the database to modify the HTTP response accordingly. In this way, the system is configured to apply a customized modification (e.g., as necessary) to each different target website that a first website may attempt to embed in an iframe or other embedded element.

In still other embodiments, the system is configured to modify one or more attributes of the embedded element (e.g., iframe) itself. For example, based on the third-party website, the system may be configured to modify one or more pieces of computer code related to the inline frame (e.g., or other embedded element) in which the third-party website is embedded.

At Step 370, the system is configured to cause the embedded element to display the target website based on the second HTTP response. The system may, for example, cause a user's web browser to display the target website as modified by the browser extension (e.g., within the embedded element or inline frame). In other embodiments, the system may cause a user's computing device to display the target website (e.g., third-party website) as modified by a native software application executing on the user device (e.g., within a WebView in the native software application).

### ILLUSTRATIVE EXAMPLES

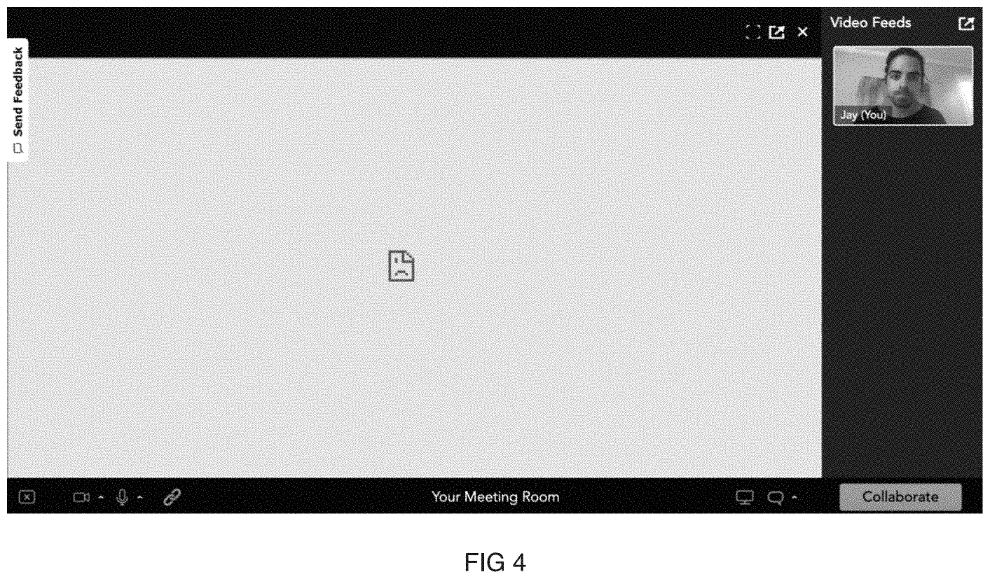

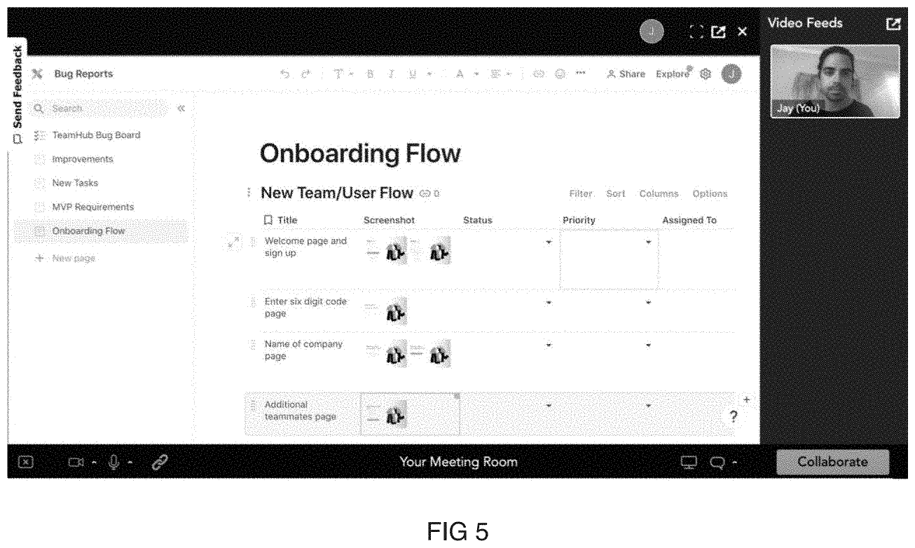

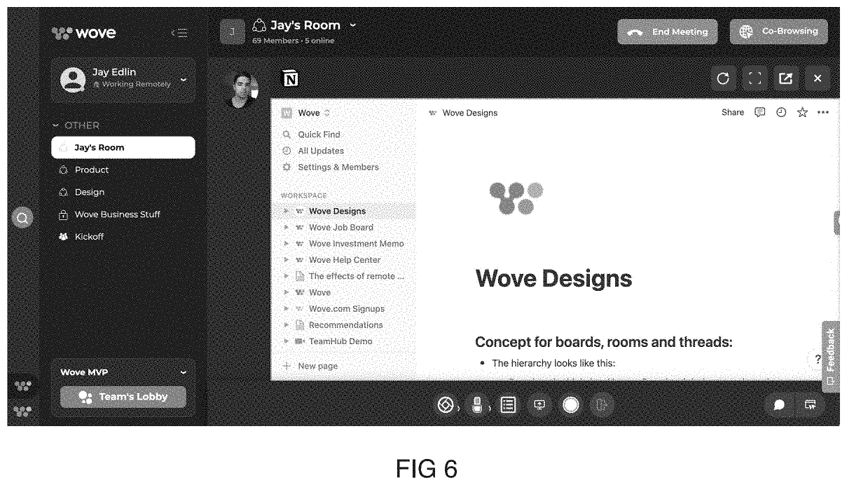

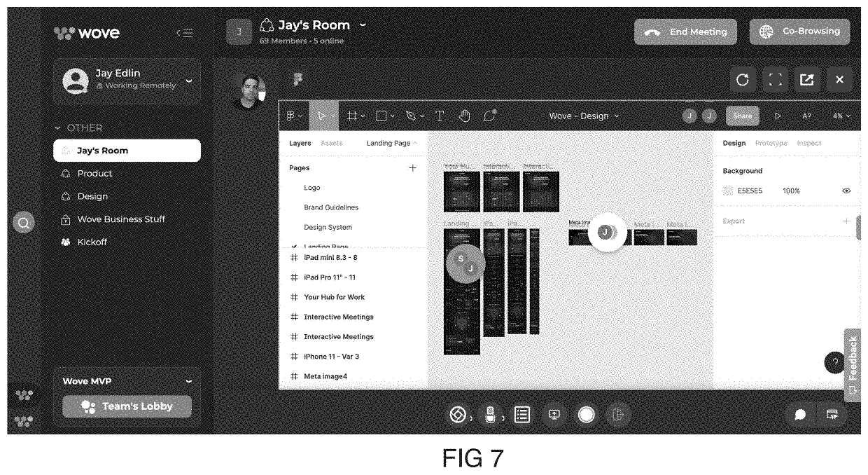

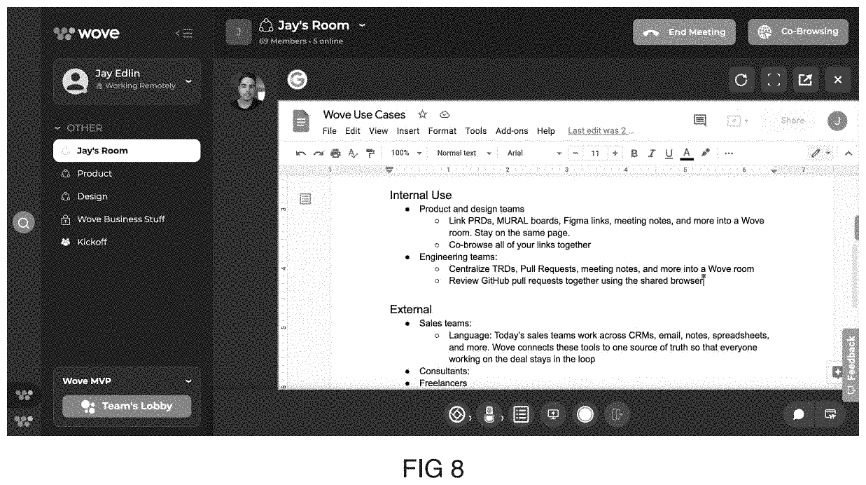

FIGS. 4 and 5 depict exemplary screen displays showing what a user may encounter when using the browser extension described herein (FIG. 5) and without using the browser extension described herein (FIG. 4). As may be understood from these figures, without the use of the browser extension or system described herein, a particular website may not display properly (and/or load at all) within an iframe, as shown in FIG. 4. When using the described system, however, a user's computing device may display the particular web site within the iframe such that the particular website appears as it would when displayed natively within a browser. In particular embodiments, the system may enable such display using any suitable technique described herein.

### CONCLUSION

Many modifications and other embodiments of the invention will come to mind to one skilled in the art to which this invention pertains having the benefit of the teachings presented in the foregoing descriptions and the associated drawings. While this specification contains many specific embodiment details, these should not be construed as limitations on the scope of any invention or of what may be claimed, but rather as descriptions of features that may be specific to particular embodiments of particular inventions. Certain features that are described in this specification in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination. For example, particular embodiments referring to one or more server devices may include a single server device, while still other embodiments referring to sever device may include a plurality of server devices.

Similarly, while operations are depicted in the drawings in a particular order, this should not be understood as requiring that such operations be performed in the particular order shown or in sequential order, or that all illustrated operations be performed, to achieve desirable results. Additionally, while some steps may be described as occurring in response to (e.g., or at least partially in response to) particular other steps, it should be understood that, in other embodiments, such steps may occur independent of (e.g., or coincident with) one another. In certain circumstances, multitasking and parallel processing may be advantageous. Moreover, the separation of various system components in the embodiments described above should not be understood as requiring such separation in all embodiments, and it should be understood that the described program components and systems may be generally integrated together in a single software product or packaged into multiple software products.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for the purposes of limitation.

What is claimed is:

1. A computer-implemented method for modifying an embedded element within a webpage, the method comprising:
intercepting, by computing hardware, a first HTTP response from a target website to a first HTTP request originating from the embedded element within the webpage;
modifying, by the computing hardware, the first HTTP response based on the target website to generate a modified HTTP response; and
causing, by the computing hardware, the embedded element to display the target website based on the modified HTTP response.

2. The computer-implemented method of claim 1, wherein:
the embedded element comprises an iframe; and
the method further comprises defining, by the computing hardware, at least one attribute for the iframe based at least in part on the modified HTTP response.

3. The computer-implemented method of claim 1, the method further comprising:
intercepting, by the computing hardware, the first HTTP request from the embedded element prior to sending the first HTTP request;
injecting, by the computing hardware, one or more headers into the first HTTP request to create a second HTTP request; and
sending, by the computing hardware, the second HTTP request in place of the first HTTP request.

4. The computer-implemented method of claim 1, the method further comprising:
accessing a cookie store associated with the target website; and
modifying the first HTTP response to inject at least one cookie from the cookie store into the first HTTP response.

5. The computer-implemented method of claim 1, wherein:
the target website comprises a collaborative user interface; and
the method further comprises enabling a plurality of users to access the collaborative user interface simultaneously via a respective embedded element in a respective browser on a respective computing device of each user of the plurality of users.

6. The computer-implemented method of claim 1, wherein the embedded element comprises a third-party website.

7. The computer-implemented method of claim 1, wherein the embedded element comprises a WebView executing a browser instance within a native application executing on a user device.

8. A computer-implemented method for modifying a website for display in an inline frame, the method comprising:
providing, by computing hardware, a browser extension for installation on a computing device;
receiving, by the computing hardware, via the browser extension, a request to render the website in the inline frame;
intercepting, by the computing hardware, an HTTP request associated with the request to render the website;
modifying, by the computing hardware, the HTTP request to a modified HTTP request by injecting at least one of: (1) one or more cookies; and (2) one or more HTTP headers into the HTTP request;
sending, by the computing hardware, to a third-party server based on a target URL associated with the HTTP request, the modified HTTP request;
receiving, by the computing hardware, in response to the modified HTTP request, an HTTP response;
modifying, by the computing hardware, the HTTP response to a modified HTTP response based on the target URL; and
configuring a computing device to display the website associated with the target URL based on the modified HTTP response within an inline frame on a second website.

9. The computer-implemented method of claim 8, wherein:
the website comprises a collaborative user interface; and
the method further comprises enabling a second computing device to access the collaborative user interface simultaneously via a respective inline frame in a respective browser on the second computing device.

10. The computer-implemented method of claim 8, wherein:
modifying the HTTP request to a modified HTTP request comprises:
accessing a database defining modification requirements for proper rendering of the website within the inline frame;
selecting at least one of the one or more cookies or the one or more HTTP headers based on the modification requirements; and
injecting the selected at least one of: (1) the one or more cookies; or (2) the one or more HTTP headers into the HTTP request.

11. The computer-implemented method of claim 8, wherein the website provides third-party computing functionality to the second website.

12. The computer-implemented method of claim 8, wherein the modified HTTP response corrects one or more rendering issues resulting from displaying the website within the inline frame according to the HTTP response.

13. The computer-implemented method of claim 8, wherein the inline frame is disposed within the second website.

14. A method for rendering third-party content in an embedded element of a website, the method comprising:
generating, by computing hardware, a graphical user interface in a portion of a browser window of a web browser executing on a computing device;
in response to the web browser retrieving a webpage to be rendered in the browser window, modifying, by the computing hardware, the webpage to be rendered based at least in part on a source of the webpage to be rendered, wherein modifying the webpage to be rendered comprises:
intercepting an HTTP response associated with the webpage to be rendered;
modifying, by the computing hardware, the HTTP response into a modified HTTP response based at least in part on the webpage to be rendered by modifying at least one attribute of the HTTP response; and
configuring, by the computing hardware, the computing device to display the website to be rendered within the portion of the browser window based at least in part on the modified HTTP request, the website to be rendered comprising the third-party content.

15. The method of claim 14, wherein the embedded element comprises an inline frame.

16. The method of claim 14, wherein the embedded element comprises WebView executing within a native application on the computing device.

17. The method of claim 14, wherein:
the method further comprises providing, by the computing hardware, a browser extension for installation on the computing device; and
modifying the webpage to be rendered comprises modifying the webpage to be rendered by the browser extension prior to rendering the webpage.

18. The method of claim 14, wherein modifying at least one attribute of the HTTP response comprises at least one of injecting at least one cookie into the HTTP response or modifying a header of the HTTP response.

19. The method of claim 14, wherein the modified HTTP response corrects one or more rendering issues resulting from displaying the website within the portion of the browser window according to the HTTP response

20. The method of claim 14, wherein the embedded element defines the portion of the browser window.
